(19) United States
(12) Patent Application Publication
(10) Pub. No.: US 2021/0345802 A1
(43) Pub. Date: Nov. 11, 2021

(54) ENCLOSABLE UTENSILS

(71) Applicant: Intercrate Container Corp., West Vancouver (CA)

(72) Inventor: Justin ELVIN-JENSEN, West Vancouver (CA)

(21) Appl. No.: 17/308,788

(22) Filed: May 5, 2021

Related U.S. Application Data
(60) Provisional application No. 63/020,428, filed on May 5, 2020.

(51) Int. Cl. A47G 21/06; A47G 21/02; B26B 3/02; A47G 21/04; A47G 21/18

(52) U.S. Cl. CPC A47G 21/06; A47G 21/023; A47G 2400/025; A47G 21/04; A47G 21/18; B26B 3/02

(57) ABSTRACT

A utensil apparatus comprises a knife portion and a fork portion. The fork portion comprises a hollowed-out fork handle and a fork head attached to the open edge of said fork handle. The knife portion similarly comprises a hollowed-out knife handle and a blade attached to the open edge of said knife handle. The fork head inserts into the knife handle and the knife blade inserts into the fork handle to interlock the fork and knife handles into a single hollow unit, while also protecting the functional components of the knife portion and the fork portion from being contaminated by unsanitary transportation conditions. The fork portion and the knife portion are self-centering; they do not need to be inserted straight into the other in order to properly interlock. As they are inserted further into the respective handle opening, curved edges on the sides of the handles cause the locking features on each respective utensil to align with the locking position.

### CROSS-REFERENCE TO RELATED APPLICATIONS

This application claims the benefit of U.S. Provisional Patent Application No. 63/020,428 filed May 5, 2020, the contents of which are hereby incorporated by reference.

### FIELD OF THE INVENTION

The invention relates to eating utensils. More particularly, this invention relates to sets of portable, reusable eating utensils.

### BACKGROUND OF THE INVENTION

Eating utensils are often made of stainless steel. Unfortunately, stainless steel is relatively heavy. Increased weight is detrimental to the portability of such utensils, particularly for use in travel where compact, lightweight equipment is desirable. Steel utensils which are light enough to be easily portable tend to be small and thin, making them uncomfortable and difficult to use.

A conventional table setting usually comprises a knife, a fork, and a spoon. In order to be portable, it is desirable to secure all three components as a unit, lest the individual components separate within a bag and become lost. One possible solution is to provide carrying cases with portable utensil sets. However, such cases add weight to the set while only providing limited additional functionality.

Another possible solution that is both lightweight and portable is an all-in-one utensil, such as the one disclosed by U.S. Pat. No. 9,265,372 to Stewart-Stand. However, many food items must be held in place using a fork while they are cut into bite-sized pieces using a knife. An all-in-one utensil cannot do both of these necessary tasks simultaneously, making it awkward and difficult to eat certain foods. Further, the functional parts of the utensil, such as the spoon bowl or fork tines, must necessarily be located at either end of the handle, forcing the user to grip the handle in the middle. This makes it more awkward to use and makes it more likely that the user's hand may accidentally come in contact with the food, which is not hygienic and may also inflict burns on the user.

Another solution is to use disposable utensils for meals eaten outside the home.

However, this is both wasteful and not environmentally friendly. Additionally, several countries have proposed bans on such single-use plastics because of the environmental impact. Accordingly, a reusable solution will be increasingly desirable and potentially a necessity in the future.

Whether portable or not, most utensils are designed so that, when rested on a surface, the part of the utensil intended to enter a person's mouth is in contact with that surface. When one is using utensils outside of the home, one cannot always be certain of the cleanliness of the surfaces on which one may need to rest the utensil. A more hygienic solution, where the functional parts of the utensil do not touch the surface on which they rest, is desirable.

It is therefore an object of this invention to provide a hygienic, light-weight, ergonomic, portable, self-containing, and reusable utensil set with all the functionality of a full table setting.

### SUMMARY OF THE INVENTION

In one aspect, the invention relates to a portable, self-contained, reusable utensil apparatus. The utensil apparatus comprises a knife portion and a fork portion. The fork portion comprises a large, ergonomic, hollowed-out fork handle and a fork head attached to the open edge of said fork handle. The knife portion similarly comprises a large, ergonomic, hollowed-out knife handle and a blade attached to the open edge of said knife handle.

The fork head inserts into the knife handle and the knife blade inserts into the fork handle to interlock the fork and knife handles into a single hollow unit, while also protecting the functional components of the knife portion and the fork portion from being contaminated by unsanitary transportation conditions. The fork portion and the knife portion are self-centering; they do not need to be inserted straight into the other in order to properly interlock. As they are inserted further into the respective handle opening, curved edges on the sides of the handles cause the locking features on each respective utensil to align with the locking position.

In another aspect, the utensil apparatus further comprises a spoon portion. The spoon portion comprises a spoon handle and a bowl attached to one end of said spoon handle. The spoon portion may be stored inside the interlocked fork portion and knife portion to protect it from contamination and misplacement.

In yet another aspect, the utensil apparatus further comprises a straw. The straw is a hollow and substantially cylindrical. The straw may have an angular bend partway along its length. The straw may be stored inside the interlocked fork portion and knife portion to protect it from contamination and misplacement.

In still yet another aspect, the utensil apparatus further comprises the spoon and straw. A groove is formed in a surface of the spoon handle, into which the straw fits snugly. The straw and spoon portion together may be stored inside the interlocked fork portion and knife portion.

In accordance with one aspect of the invention, a utensil apparatus comprises a fork portion and a knife portion. The fork portion comprises a fork handle and a fork head. The fork handle comprises first and second fork walls and a fork cross wall extending between the first and second fork walls. The fork head extends from the first fork wall. The knife portion comprises a knife handle and a blade. The knife handle comprises first and second knife walls and a knife cross wall extending between the first and second knife walls. The blade extends from the first knife wall. The first and second fork walls and the fork cross wall define, at least in part, a fork enclosure. The first and second knife walls and the knife cross wall define, at least in part, a knife enclosure. The fork portion is configured to engage with the knife portion to form a connected configuration in which the fork head is housed, at least in part, within the knife enclosure, and the blade is housed, at least in part, within the fork enclosure.

In another embodiment, the fork first wall is curved and the fork second wall is substantially planar.

In yet another embodiment, the knife first wall is curved and the knife second wall is substantially planar.

In still yet another embodiment, the fork cross wall is U-shaped.

In a further embodiment, the knife cross wall is U-shaped.

In still a further embodiment, the fork cross wall comprises fork cross wall edges and the knife cross wall comprises knife cross wall edges. In the connected configuration, the fork cross wall edges engage with the knife cross wall edges.

In yet another embodiment, the fork cross wall edges and the knife cross wall edges are curved.

In still yet another embodiment, the fork head comprises a plurality of tines.

In still a further embodiment, the blade comprises a knife tab, and the second fork wall comprises a fork slot, the knife tab being configured to engage with the fork slot when in the connected configuration.

In another embodiment, the fork head comprises a fork tab, and the second knife wall comprises a knife slot, the fork tab being configured to engage with the knife slot when in the connected configuration.

In still another embodiment, in the connected configuration, the fork enclosure and the knife enclosure form a cavity that is substantially sealed.

In yet another embodiment, the utensil apparatus further comprises a spoon portion, and in the connected configuration, the spoon portion is configured to fit within the cavity.

In still yet another embodiment, the utensil apparatus further comprises a straw, and in the connected configuration, the straw is configured to fit within the cavity.

In a further embodiment, the spoon portion comprises a spoon handle and a bowl extending from the spoon handle. The spoon handle comprises a groove for accommodating the straw.

In still a further embodiment, the fork head is curved.

In still yet a further embodiment, the first fork wall comprises a first fork edge. The fork head extends from the first fork wall proximate to the first fork edge.

In another embodiment, the first fork wall is offset from the fork head.

In still another embodiment, the first knife wall comprises a first knife edge. The blade extends from the first knife wall proximate to the first knife edge.

In a further embodiment, the first knife wall is offset from the blade.

The foregoing was intended as a summary only and of only some of the aspects of the invention. It was not intended to define the limits or requirements of the invention. Other aspects of the invention will be appreciated by reference to the detailed description of the embodiments.

### BRIEF DESCRIPTION OF THE DRAWINGS

Accompanying drawings show an exemplary embodiment in accordance with one or more aspects of the invention; however, the accompanying drawings should not be taken to limit the invention to the embodiment shown, but are for explanation and understanding only.

FIG. 1 is a perspective view of the utensil apparatus in accordance with the invention;

FIG. 2 is a side view of the utensil apparatus of FIG. 1;

FIG. 3 is an exploded view of the utensil apparatus of FIG. 1;

FIG. 4 is another exploded view of the utensil apparatus of FIG. 1;

FIG. 5 is a side view of the fork portion of the utensil apparatus resting on a surface in one orientation;

FIG. 6 is a side view of the fork portion of the utensil apparatus resting on a surface in another orientation;

FIG. 7 is a side view of the knife portion of the utensil apparatus resting on a surface in one orientation;

FIG. 8 is a side view of the knife portion of the utensil apparatus resting on a surface in another orientation;

FIG. 9 is a side view of the fork portion and the knife portion of the utensil apparatus before being connected together;

FIG. 10 is a side view of the fork portion, the knife portion, the spoon portion, and the straw of the utensil apparatus before being connected together;

FIG. 11 is a top view of the fork portion and the knife portion being connected together;

FIG. 12 is a top view of the fork portion and the knife portion further in the process of being connected together;

FIG. 13 is a perspective view of the fork portion and the knife portion being connected together;

FIG. 14 is another perspective view of the fork portion and the knife portion being connected together;

FIG. 15 is a perspective view of the fork portion and the knife portion further in the process of being connected together;

FIG. 16 is a sectional side view of the utensil apparatus of FIG. 1, taken along plane 2-2 of FIG. 2;

FIG. 17 is a sectional perspective view of the utensil apparatus of FIG. 1 without the straw, taken along plane 2-2 of FIG. 2;

FIG. 18 is a sectional perspective view of the utensil apparatus of FIG. 1, taken along plane 2-2 of FIG. 2;

FIG. 19 is a sectional perspective view of the utensil apparatus of FIG. 1 without the straw and with the spoon portion in a different orientation, taken along plane 2-2 of FIG. 2;

FIG. 20 is a sectional perspective view of the utensil apparatus of FIG. 1 with the spoon portion in a different orientation, taken along plane 2-2 of FIG. 2;

FIG. 21 is an exploded view of one embodiment of the utensil apparatus; and

FIG. 22 is an exploded view of another embodiment of the utensil apparatus.

### DETAILED DESCRIPTION

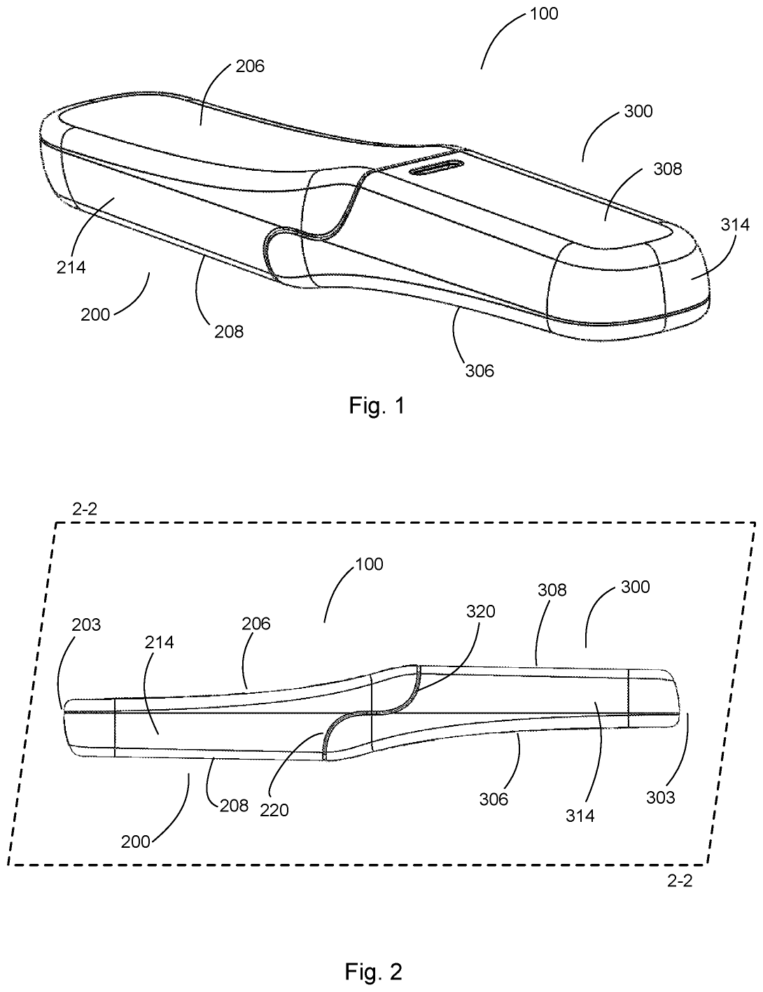

Referring to FIGS. 1 and 2, the utensil apparatus 100 comprises a fork portion 200 and a knife portion 300. The fork portion 200 and the knife portion 300 may be used separately (as a fork and knife, respectively) but they may also connect together for transportation in a manner described below. For example, FIG. 2 shows the fork portion 200 and the knife portion 300 connected together to form a single unit. Furthermore, the utensil apparatus 100 may also comprise a spoon portion 400 and may also comprise a straw 500.

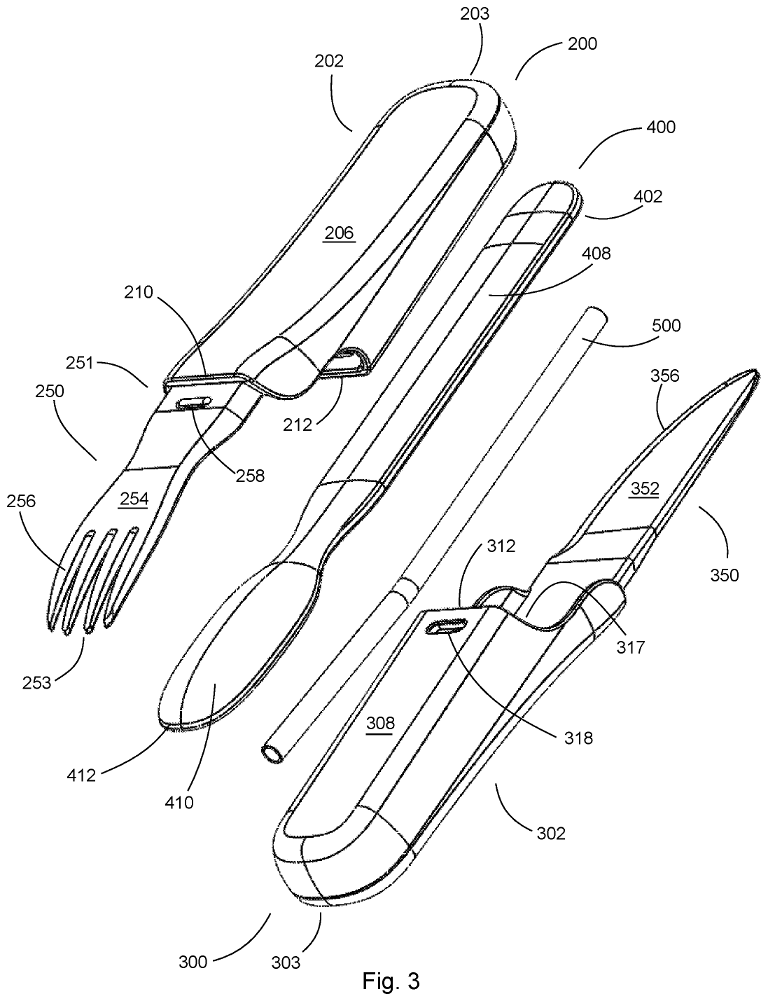

Referring to FIGS. 3 and 4, which show exploded views of the utensil apparatus 100, the fork portion 200 preferably comprises a fork handle 202 attached to a fork head 250. The fork handle 202 is adapted to be gripped by hand and comprises a fork end 203, with a first fork wall 206 and a second fork wall 208 extending from the fork end 203. The first fork wall 206 and the second fork wall 208 are generally spaced apart from each other. The first fork wall 206 comprises a first fork edge 210 that extends along a portion of the first fork wall 206 distal from the fork end 203. The second fork wall 208 comprises a second fork edge 212 that extends along a portion of the second fork wall 208 distal from the fork end 203. Preferably, the first fork wall 206 and the second fork wall 208 are not parallel to each other, but instead, the first fork wall 206 generally curves away from the second fork wall 208 as it extends from the fork end 203, as seen in FIG. 2. The second fork wall 208 may be substantially planar.

A fork cross wall 214 extends between the first fork wall 206 and the second fork wall 208. Preferably, the fork cross wall 214 extends from the periphery of the first fork wall 206 except at the first fork edge 210. The fork cross wall 214 preferably extends from the second fork wall 208 along the periphery of the second fork wall 208 except at the second fork edge 212.

Referring to FIGS. 3 and 4, the fork cross wall 214 is preferably continuous and curved, but may also be formed from a plurality of individual segments. The fork cross wall 214 is generally U-shaped (wrapping around the fork end 203). The first and second fork walls 206, 208 and the fork cross wall 214 generally define, at least in part, a fork enclosure 216. The fork cross wall 214 comprises two fork cross wall edges 220 formed at ends of the fork cross wall 214. In the embodiment shown in FIGS. 3 and 4, the fork cross wall edges 220 are generally curved. Furthermore, the first fork wall 206 is preferably longer than the second fork wall 208.

A fork slot 218 is formed on the second fork wall 208 proximate to the second fork edge 214.

The fork head 250 comprises first and second fork head ends 251, 253. The first fork head end 251 is connected to the first fork wall 206, proximate to the first fork edge 210. Preferably, the fork head 250 extends from the first fork edge 210 at an angle such that it is angled or curved towards a plane A of the second fork wall 208, as best seen in FIG. 6. The fork head 250 further comprises first and second head surfaces 252, 254, with a fork tab 258 formed on the second head surface 254 proximate to the first fork edge 210.

The first head surface 252, the fork cross wall edges 220, and the second fork edge 212 generally define, at least in part, a fork enclosure opening 217 that leads to the fork enclosure 216.

A plurality of tines 256 are formed on the second fork head end 253.

Referring to FIGS. 3 and 4, the knife portion 300 comprises a knife handle 302 attached to a blade 350. The knife handle 302 is adapted to be gripped by hand and comprises a knife end 303, with a first knife wall 306 and a second knife wall 308 extending from the knife end 303. The first knife wall 306 and the second knife wall 308 are generally spaced apart from each other. The first knife wall 306 comprises a first knife edge 310 that extends along a portion of the first knife wall 306 distal from the knife end 303. The second knife wall comprises a second knife edge 312 that extends along a portion of the second knife wall 308 distal from the knife end 303. Preferably, the first knife wall 306 and the second knife wall 308 are not parallel to each other, but instead, the first knife wall 306 generally curves away from the second knife wall 308 as it extends from the knife end 303, as seen in FIG. 2. The second knife wall 308 may be substantially planar.

A knife cross wall 314 extends between the first knife wall 308 and the second knife wall 308. Preferably, the fork cross wall 314 extends from the periphery of the first knife wall 306 except at the first knife edge 310. The knife cross wall 314 extends substantially perpendicularly from the portion of the periphery of the first knife wall 306 that does not include the first knife edge 310. The knife cross wall 314 preferably extends from the second knife wall 308 along the periphery of the second knife wall 308 except at the second knife edge 312.

Referring to FIGS. 3 and 4, the knife cross wall 314 is preferably continuous and curved, but may also be formed from a plurality of individual segments. The knife cross wall 314 is generally U-shaped (wrapping around the knife end 303). The first and second knife walls 306, 308 and the knife cross wall 314 generally define, at least in part, a knife enclosure 316. The knife cross wall 314 comprises two knife cross wall edges 320 formed at ends of the knife cross wall 314. In the embodiment shown in FIGS. 3 and 4, the knife cross wall edges 320 are generally curved. Furthermore, the first knife wall 306 is preferably longer than the second knife wall 308.

A knife slot 318 is formed on the second knife wall 308 proximate to the second knife edge 314.

The blade 350 comprises first and second blade ends 351, 353. The first blade end 351 is connected to the first knife wall 306, proximate to the first knife edge 310. Preferably, the blade 350 extends from the first knife edge 310 at an angle such that it is substantially parallel to a plane B of the second knife wall 308, as best seen in FIG. 8. Alternatively, the blade 350 may be angled towards the plane B of the second knife wall 308. The blade 350 first comprises first and second blade surfaces 352, 354, with a knife tab 358 formed on the second blade surface 354 proximate to the first knife edge 310.

The first blade surface 352, the knife cross wall edges 320, and the second knife edge 312 generally define, at least in part, a knife enclosure opening 317 that leads to the knife enclosure 316.

The blade 350 also comprises at least one cutting edge 356 with serrations 360 preferably formed along the cutting edge 356 on either or both of the first blade surface 352 and the second blade surface 354.

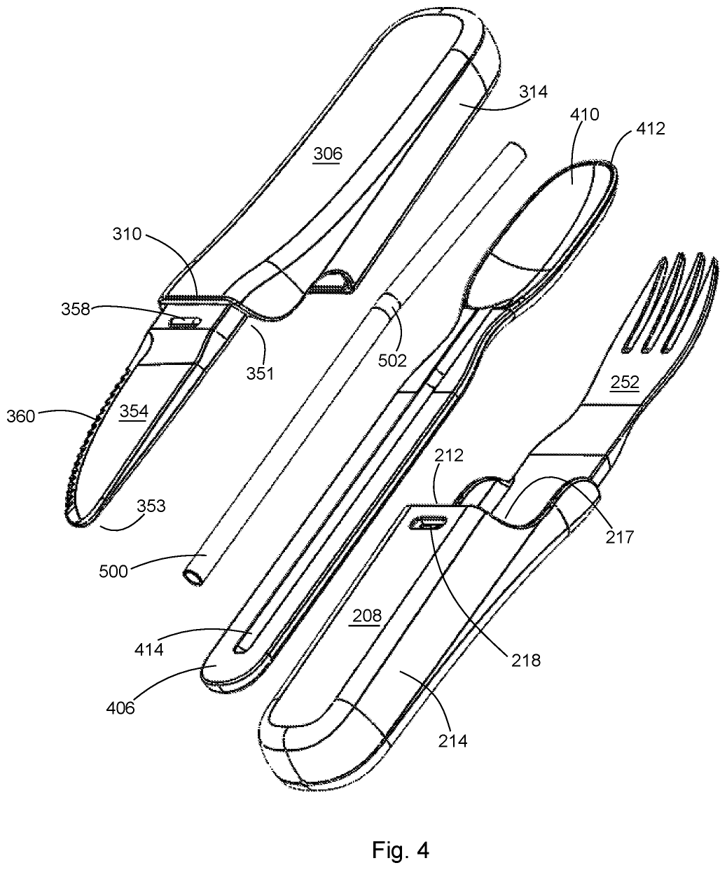

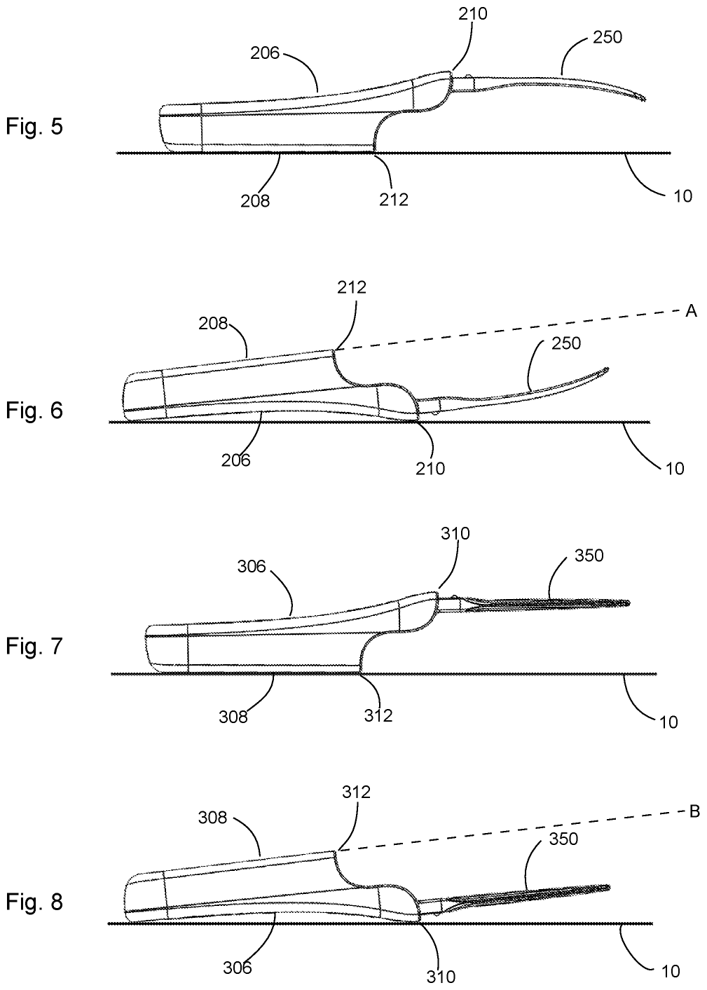

Referring to FIGS. 5 and 6, the majority of the weight of the fork portion 200 is preferably concentrated in the fork handle 202. Therefore, when the fork portion 200 is placed on an exemplary surface 10, with the second fork wall 208 contacting the surface 10 (as shown in FIG. 5), the fork head 250 will preferably not touch the surface 10. This is because the weight of the fork head 250 is insufficient to cause the fork portion 200 to tip at the second fork edge 212. In other words, the second fork wall 208 is able to remain substantially in contact with the surface 10, thereby preventing the second fork head end 253 (or any other portion of the fork head 250) from contacting the surface 10. This helps to prevent any unintentional contamination of the fork head 250 by the surface 10.

Referring to FIG. 6, when the fork portion 200 is placed on the surface 10, with the first fork wall 206 contacting the surface 10, the fork head 250 will also preferably not touch the surface 10. Again, this is because the weight of the fork head 250 is insufficient to cause the fork portion 200 to tip at the first fork edge 210. In addition, the angling or curving of the fork head 250 (as discussed above) aids in preventing the second fork end 253 (or any other portion of the fork head 250) from contacting the surface 10. This helps to prevent any unintentional contamination of the fork head 250 by the surface 10.

Referring to FIGS. 7 and 8, the majority of the weight of the knife portion 300 is preferably concentrated in the knife handle 302. Therefore, when the knife portion 300 is placed on the surface 10, with the second knife wall 308 contacting the surface 10 (as shown in FIG. 7), the blade 350 will preferably not touch the surface 10. This is because the weight of the blade 350 is insufficient to cause the knife portion 300 to tip at the second knife edge 312. In other words, the second knife wall 308 is able to remain substantially in contact with the surface 10, thereby preventing the second blade end 353 (or any other portion of the blade 350) from contacting the surface 10. This helps to prevent any unintentional contamination of the blade 350 by the surface 10.

Referring to FIG. 8, when the knife portion 300 is placed on the surface 10, with the first knife wall 306 contacting the surface 10, the blade 350 will also preferably not touch the surface 10. Again, this is because the weight of the blade 350 is insufficient to cause the knife portion 300 to tip at the first knife edge 310. In addition, the angling of the blade 350 (as discussed above) aids in preventing the second blade end 353 (or any other portion of the blade 350) from contacting the surface 10. This helps to prevent any unintentional contamination of the blade 350 by the surface 10.

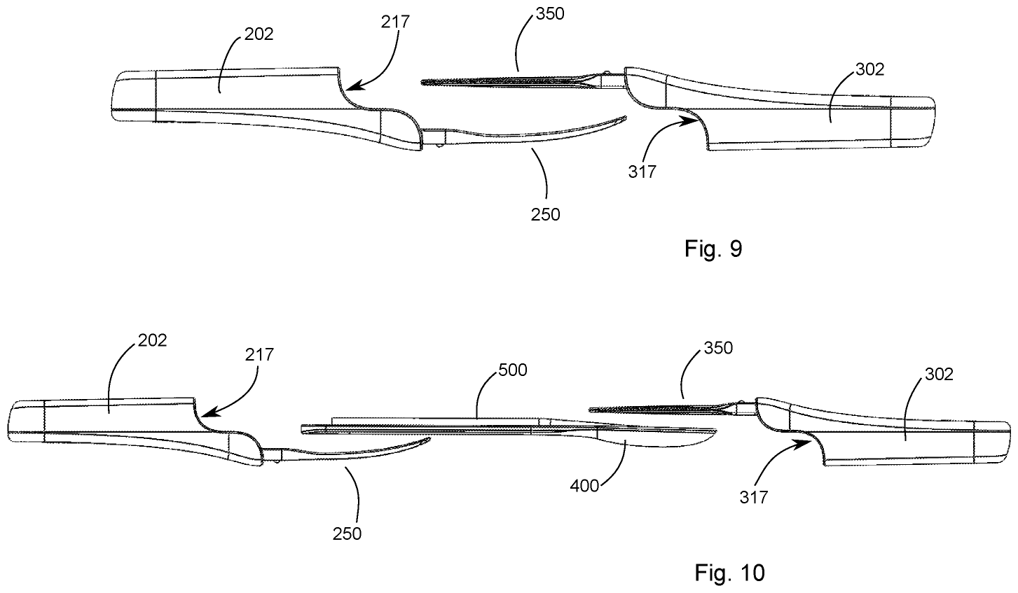

Referring to FIGS. 9 to 10, the fork portion 200 can connect with the knife portion 300. When the fork portion 200 and knife portion 300 are connected together, the resultant combination has a cavity 150 defined, at least in part, by the fork enclosure 216 and the knife enclosure 316.

The procedure for connecting the fork portion 200 and the knife portion 300 is initiated by moving the second fork head end 253 towards the second blade end 353. The first head surface 252 should be facing the first blade surface 352, as shown in the orientation depicted in FIG. 9. Next, the fork head 250 is inserted through the knife enclosure opening 317 and into the knife enclosure 316, and the blade 350 is inserted through the fork enclosure opening 217 into the fork enclosure 216.

The fork handle 202 and the knife handle 302 are then brought into closer proximity with each other. As they are brought closer together, the fork tab 258 will come into contact with the second knife wall 308, such as at the second knife edge 312. This contact will cause the fork head 250 to deform and flex slightly (in a direction towards the second fork wall 208) as the fork tab 258 moves along the second knife wall 308. At about the same time, the knife tab 358 will come into contact with the second fork wall 208, such as at the second fork edge 212. This contact will cause the blade 350 to deform and flex slightly (in a direction towards the second knife wall 308) as the knife tab 358 moves along the second fork wall 208.

The fork handle 202 and the knife handle 302 are continued to be brought closer together until the fork cross wall edges 220 engage with the knife cross wall edges 320. Preferably, the fork cross wall edges 220 and the knife cross wall edges 320 are shaped such that they are able to mateably engage, with the fork cross wall 214 and the knife cross wall 314 forming a generally continuous surface. When the fork cross wall edges 220 engage with the knife cross wall edges 320, the first fork edge 210 is brought into contact with the second knife edge 312, and the second fork edge 212 is brought into contact with the first knife edge 310. Preferably, when the first fork edge 210 contacts the second knife edge 312 and the second fork edge 212 contacts the first knife edge 310, the fork tab 258 will engage with the knife slot 318 and the knife tab 358 will engage with the fork slot 218. The engagement of the fork tab 258 with the knife slot 318 causes the fork head 250 to revert back to its original posture. Similarly, the engagement of the knife tab 358 with the fork slot 218 causes the blade 350 to revert back to its original posture.

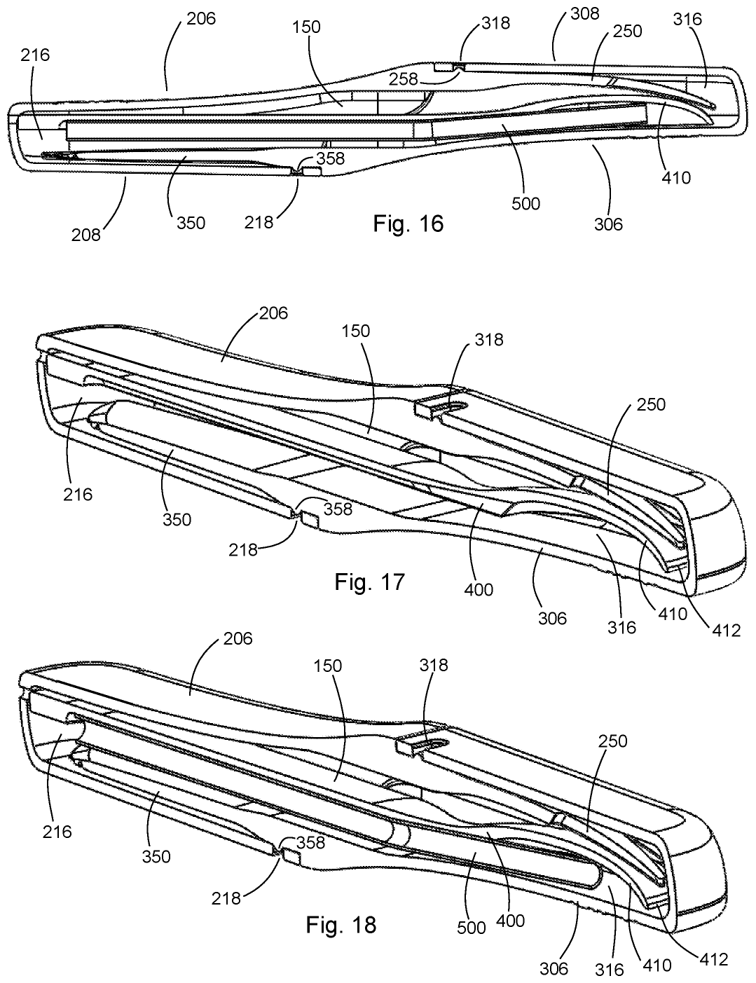

The engagement of the fork tab 258 and the knife tab 358 with the knife slot 318 and the fork slot 218, respectively, helps to secure the fork portion 200 and the knife portion 300 together. FIG. 1 depicts the fork and knife tabs 258, 358 engaged within the knife and fork slots 318, 218, respectively. FIGS. 16 to 18 depict a sectional view (taken along plane 2-2 of FIG. 2) of the utensil apparatus 100. FIGS. 16 to 18 depict the fork portion 200 and the knife portion 300 connected together, with the fork head 250 located within the knife enclosure 316 and the blade 350 located within the fork enclosure 216. Applications of small amounts of force, such as the jostling or bumping of the utensil apparatus 100 that would be expected while being transported, for example in a bag, are preferably not sufficient to separate the fork portion 200 from the knife portion 300.

The releasing of the fork portion 200 from the knife portion 300 will now be described. When sufficient force is applied to pull the fork portion 200 apart from the knife portion 300, the fork and knife tabs 258, 358 will disengage from the knife and fork slots 318, 218, respectively, causing a deformation and flexing of the fork head 250 and the blade 350. This deformation and flexing of the fork head 250 and the blade 350 allow the fork and knife tabs 258, 358 to slide along the second knife and fork walls 308, 208, respectively. When the fork tab 258 moves past the second knife edge 312, the fork head 250 can revert back to its original posture. Similarly, when the knife tab 358 moves past the second fork edge 212, the blade 350 can revert back to its original posture. The fork portion 200 and the knife portion 300 are now separated and can be used separately.

As shown in FIG. 3, the fork head second surface 254 is preferably not continuous with the first fork wall 206, but is instead offset from the first fork wall 206. This allows the second knife wall 308 to engage with the first fork wall 206 and form a generally continuous surface.

Similarly, as shown in FIG. 4, the second blade surface 354 is preferably not continuous with the first knife wall 306, but is instead offset from the first knife wall 306. This allows the second fork wall 208 to engage with the first knife wall 306 and form a generally continuous surface.

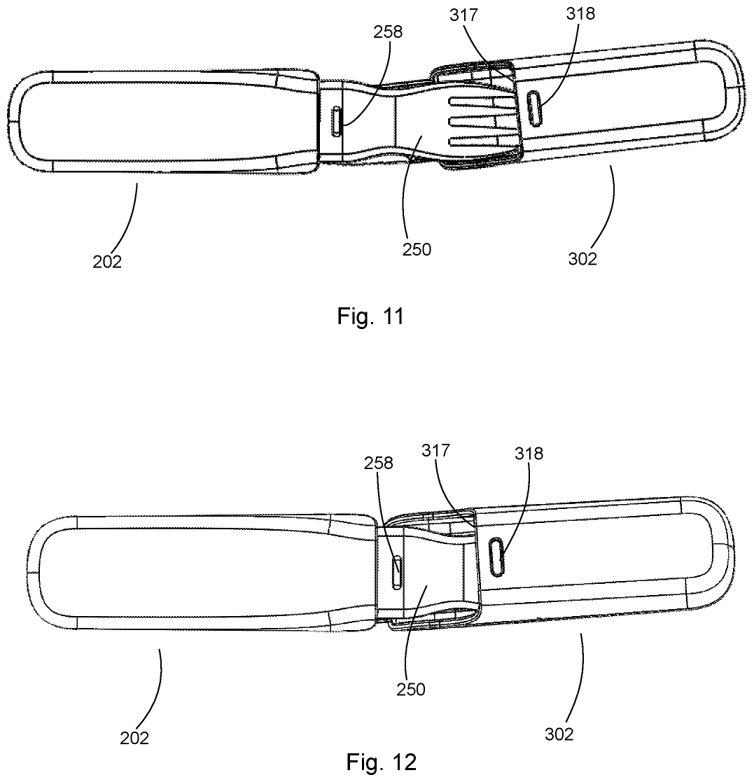

Referring to FIGS. 11 to 15, the connecting action of the fork portion 200 with the knife portion 300 is preferably self-centering. The user need not precisely align the fork tab 258 with the knife slot 318 and the knife tab 358 with the fork slot 218 while bringing the fork portion 200 and knife portion 300 together. In FIGS. 11 and 12, the fork head 250 is inserted through the knife enclosure opening 317 at an angle (horizontally). As the fork head 250 is pushed further through the knife enclosure opening 317 (see FIG. 11), the second fork head end head 253 will engage with the knife cross wall 314. This engagement causes the fork head 200 to begin to realign with the knife portion 300, as the second fork head end 253 slides along the knife cross wall 314. As the fork head 250 is inserted further into the knife enclosure 316 through the knife enclosure opening 317, the fork portion 200 will become more and more aligned with the knife portion 300, as shown in FIG. 12. Once the fork cross wall edges 220 engages with the knife cross wall edges 320, the realignment is completed.

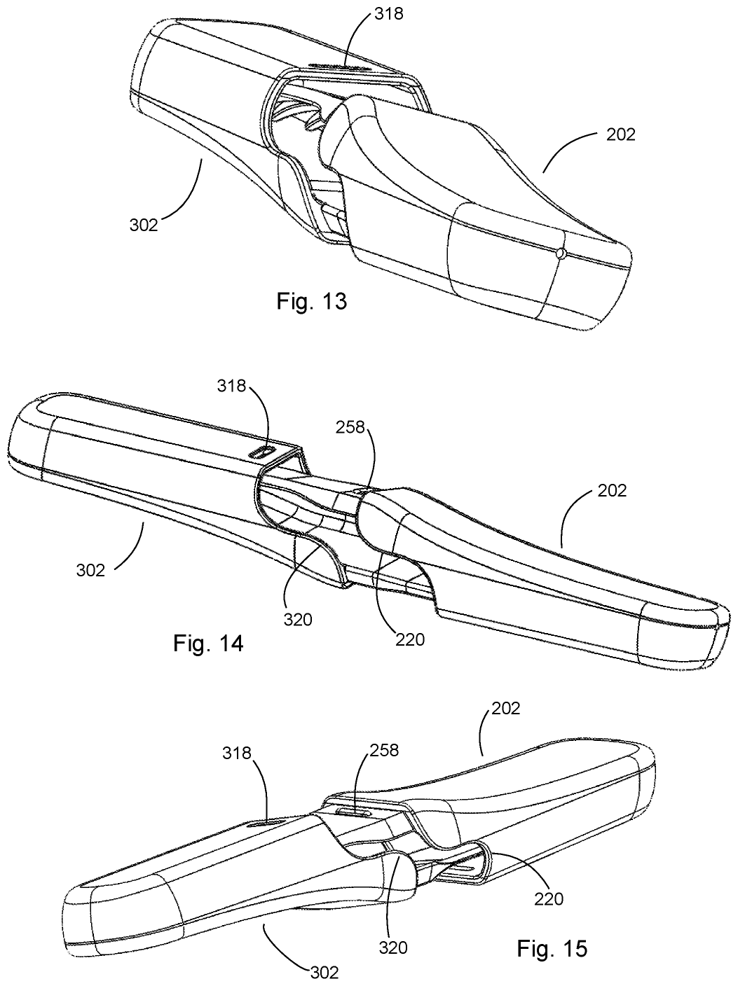

FIGS. 13 to 15 depicts the fork portion 200 and the knife portion 300 in the process of being connected together, where the first head surface 252 is not directly facing the first blade surface 352 (i.e. the fork portion 200 and the knife portion 300 are not vertically or angularly aligned). The fork head 250 can still be inserted into the knife enclosure 316 in this state of misalignment. As the fork head 250 is inserted further into the knife enclosure 316 (see FIGS. 13 and 14), the fork cross wall edges 220 begin to engage with the knife cross wall edges 320.

Because of the curved nature of the fork cross wall edges 220 and the knife cross wall edges 320, their engagement assists in aligning the first head surface 252 with the first blade surface 352 (see FIG. 15).

Referring to FIGS. 3 and 4, the spoon portion 400 comprises a bowl 410 and a spoon handle 402 extending from the bowl 410. The spoon handle 402 is adapted to be gripped by hand and comprises first and second spoon surfaces 406, 408. The bowl 410 comprises a bowl edge 412 extending along at least a portion of the perimeter of the bowl 410.

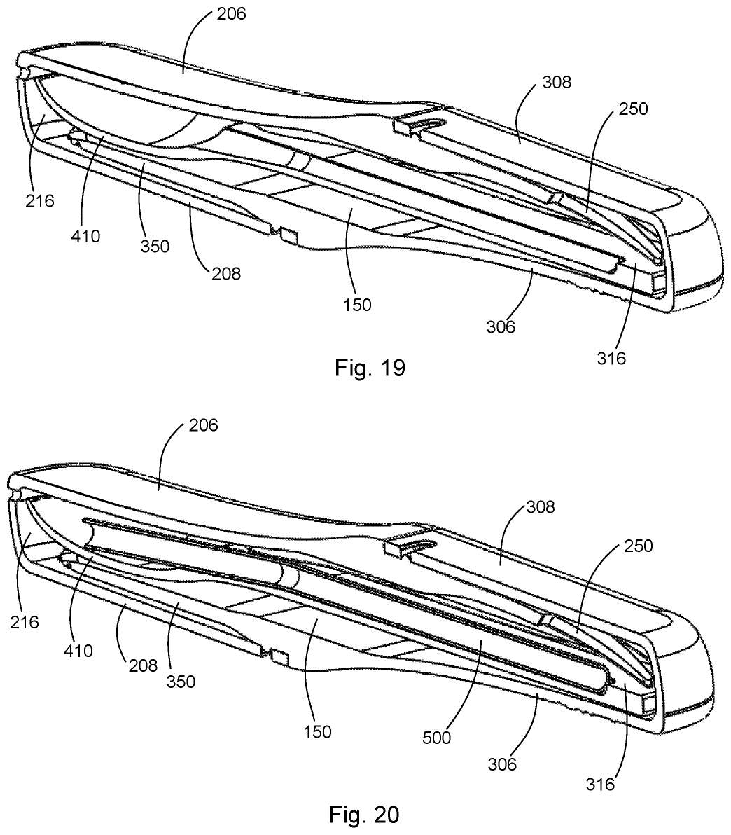

The spoon portion 400 is preferably sized so that it fits within the cavity 150 when the fork portion 200 and the knife portion 300 are connected together. Referring to FIGS. 16 to 20, the spoon portion 400 may be fitted within the cavity 150 in different orientations. For example, the spoon portion 400 may be fitted within the cavity 150 such that the bowl 410 is placed primarily within the knife enclosure 316, with the bowl edge 412 facing the first knife wall 306, as shown in FIGS. 16 to 18. Alternatively, the spoon portion 400 may be fitted within the cavity 150 such that the bowl 410 is placed primarily within the fork enclosure 216, with the bowl 410 facing the first fork wall 206, as shown in FIGS. 19 to 20.

Referring to FIGS. 3 and 4, the straw 500 is preferably substantially cylindrical in shape and is adapted to allow suction of liquid through its length. The straw 500 may comprise a bendable portion 502 partway along its length, with the bendable portion 502 adapted to allow for bending of the straw 500. The straw 500 is preferably sized so that it fits within the cavity 150 when the fork portion 200 and the knife portion 300 are connected together.

In one embodiment, the utensil apparatus 100 comprises the spoon portion 400 and the straw 500. In this embodiment, a groove 414 is formed on the first spoon surface 406, as shown in FIG. 4. The groove 414 is preferably semicircular in cross-section and is preferably sized to receive the straw 500, as shown in FIGS. 18 and 20. The groove 414 may extend for substantially an entire length of the spoon handle 402. Preferably, the straw 500 is shorter than the spoon portion 400.

The utensil apparatus 100 preferably comprises at least the fork portion 200 and the knife portion 300. The spoon portion 400 and/or the straw 500 may be left out of the utensil apparatus 100 or may form part of the utensil apparatus 100.

When the fork portion 200 and the knife portion 300 are connected together, the first and second fork walls 206, 208, the fork cross wall 214, the first and second knife walls 306, 308, and the knife cross wall 314 generally define an enclosure (i.e. the cavity 150) that is preferably sealed. This ensures that the fork head 250 and the blade 350 are protected from contamination as they are prevented from coming into contact with foreign substances or foreign surfaces when the fork portion 200 and the knife portion 300 are connected together. If the utensil apparatus 100 includes the spoon portion 400 and/or the straw 500, the spoon portion 400 and/or the straw 500 are also protected from contamination when placed within the cavity 150 after the fork portion 200 and the knife portion 300 are connected together.

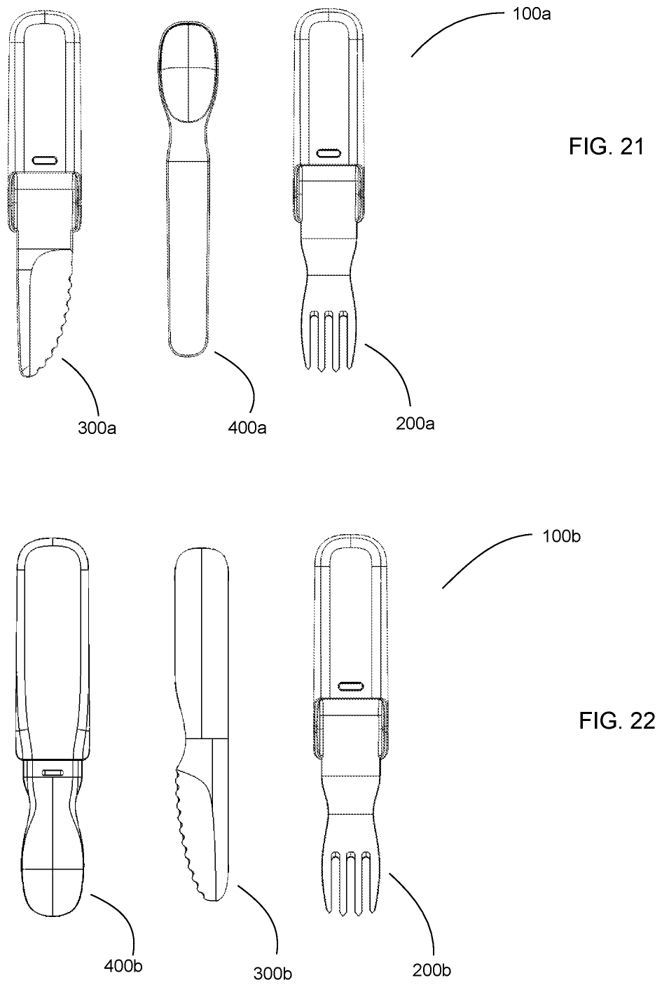

FIGS. 21 and 22 depict different embodiments of the utensil apparatus 100. In FIG. 21, the utensil apparatus 100a comprises fork portion 200a and knife portion 300a that may connect together (as described above), with the spoon portion 400a adapted to be stored within the connected fork portion 200a and knife portion 300a. In FIG. 22, the utensil apparatus 100b comprises fork portion 200b and spoon portion 400b that may be connected together, with the knife portion 300b adapted to be stored within the connected fork portion 200b and spoon portion 400b. In this embodiment, the spoon portion 400b has a structure similar to the knife portion 300a (as described above).

One or more of the components of the utensil apparatus 100 may be formed from plastic, using, for example, injection moulding techniques. By using plastic, the utensil apparatus 100 may be reusable and is sturdy enough for repeated uses.

It will be appreciated by those skilled in the art that the preferred embodiment has been described in some detail but that certain modifications may be practiced without departing from the principles of the invention.

1. A utensil apparatus comprising:
a fork portion comprising:
a fork handle comprising:
first and second fork walls; and
a fork cross wall extending between the first and second fork walls;
a fork head extending from the first fork wall; and
a knife portion comprising:
a knife handle comprising:
first and second knife walls; and
a knife cross wall extending between the first and second knife walls;
a blade extending from the first knife wall;
wherein the first and second fork walls and the fork cross wall define, at least in part, a fork enclosure;
wherein the first and second knife walls and the knife cross wall define, at least in part, a knife enclosure; and
wherein the fork portion is configured to engage with the knife portion to form a connected configuration in which the fork head is housed, at least in part, within the knife enclosure, and the blade is housed, at least in part, within the fork enclosure.

2. The utensil apparatus of claim 1, wherein the fork first wall is curved and the fork second wall is substantially planar.

3. The utensil apparatus of claim 1, wherein the knife first wall is curved and the knife second wall is substantially planar.

4. The utensil apparatus of claim 1, wherein the fork cross wall is U-shaped.

5. The utensil apparatus of claim 1, wherein the knife cross wall is U-shaped.

6. The utensil apparatus of claim 1, wherein the fork cross wall comprises fork cross wall edges and the knife cross wall comprises knife cross wall edges, and wherein in the connected configuration, the fork cross wall edges engage with the knife cross wall edges.

7. The utensil apparatus of claim 6, wherein the fork cross wall edges and the knife cross wall edges are curved.

8. The utensil apparatus of claim 1, wherein the fork head comprises a plurality of tines.

9. The utensil apparatus of claim 1, wherein the blade comprises a knife tab and wherein the second fork wall comprises a fork slot, the knife tab being configured to engage with the fork slot when in the connected configuration.

10. The utensil apparatus of claim 1, wherein the fork head comprises a fork tab and wherein the second knife wall comprises a knife slot, the fork tab being configured to engage with the knife slot when in the connected configuration.

11. The utensil apparatus of claim 1, wherein in the connected configuration, the fork enclosure and the knife enclosure form a cavity that is substantially sealed.

12. The utensil apparatus of claim 11, further comprising a spoon portion, wherein in the connected configuration, the spoon portion is configured to fit within the cavity.

13. The utensil apparatus of claim 12, further comprising a straw, wherein in the connected configuration, the straw is configured to fit within the cavity.

14. The utensil apparatus of claim 13, wherein the spoon portion comprises a spoon handle and a bowl extending from the spoon handle, and wherein the spoon handle comprises a groove for accommodating the straw.

15. The utensil apparatus of claim 1, wherein the fork head is curved.

16. The utensil apparatus of claim 1, wherein the first fork wall comprises a first fork edge, wherein the fork head extends from the first fork wall proximate to the first fork edge.

17. The utensil apparatus of claim 1, wherein the first fork wall is offset from the fork head.

18. The utensil apparatus of claim 1, wherein the first knife wall comprises a first knife edge, wherein the blade extends from the first knife wall proximate to the first knife edge.

19. The utensil apparatus of claim 1, wherein the first knife wall is offset from the blade.
